(19) United States
(12) Patent Application Publication
(10) Pub. No.: US 2019/0271765 A1
(43) Pub. Date: Sep. 5, 2019

(54) POLARIMETRIC RADAR SYSTEM AND METHOD FOR CLASSIFYING OBJECTS AHEAD OF A VEHICLE

(71) Applicant: IEE INTERNATIONAL ELECTRONICS & ENGINEERING S.A., Echtemach (LU)

(72) Inventors: Kais BEN KHADHRA, Mamer (LU); Oscar GOMEZ, Paris (FR); Jochen LANDWEHR, Trier (DE)

(21) Appl. No.: 16/347,101

(22) PCT Filed: Nov. 13, 2017
(86) PCT No.: PCT/EP2017/079060

§ 371 Date: May 2, 2019

(30) Foreign Application Priority Data
Nov. 14, 2016 (LU) 93 302

(51) Int. Cl. G01S 7/41; G01S 7/02; G01S 13/93

(52) U.S. Cl. CPC G01S 7/412; G01S 13/931; G01S 7/025

(57) ABSTRACT

A polarimetric radar system for classifying objects ahead of a vehicle includes a radar transmitter unit for transmitting radar waves of at least two different polarizations, a radar receiving unit for receiving radar waves of at least two different polarizations, a radar signal generating unit for generating and providing radar waves to be transmitted by the at least one radar transmitter unit, a signal processing circuitry for processing the generated radar waves to be transmitted and the received radar waves, and a signal evaluation unit that is configured to receive processed signals from the signal processing circuitry, to estimate values for a set of predetermined object parameters on the basis of the received processed signals, and to select an object classification upon detecting a match of the estimated values for the set of object parameters with one out of a plurality of predetermined sets of object parameters.

### TECHNICAL FIELD

The invention relates to a polarimetric radar system for classifying objects ahead of a vehicle and a method of classifying objects ahead of a vehicle by using such polarimetric radar system, and a software module for controlling automatic execution of the method.

### BACKGROUND OF THE INVENTION

It is known in the art to employ radar technology in exterior automotive applications for providing improved safety by facilitating an optimized reaction of a driver of a vehicle with appropriate warnings.

For instance, patent application publication JP 2004085564 A describes an apparatus and a method for determining the condition of a road surface. In the method, a radio wave is irradiated to the road which is covered by a radio wave reflector, and the reflected radio wave is received. Based on a change in the received radio wave with respect to the irradiated radio wave, the presence or absence of water or ice on the road is determined.

Further, European patent application EP 2 653 882 A1 describes a method of using radar technology for road condition recognition, in particular for detecting low-friction spots caused by water, ice or snow on asphalt. The method comprises measuring monostatic (radar transmitter and receiver are co-located) backscattering from an asphalt sample at various incidence angles, eliminating effects of unknown parameters by computing ratios of backscattered signals for different polarizations, and identifying water and ice based on the change in the backscattering properties of the asphalt by comparing the ratios of backscattering coefficients at vv (vertical)-polarizations and hh (horizontal)-polarizations. 24 GHz radar for road condition recognition is described to be feasible for detecting low-friction spots.

Patent application EP 2 653 882 A1 further cites several studies on employing automotive radars for road condition recognition using bistatic (transmitter and receiver are arranged at different locations) scattering measurements, wherein scattering from road surfaces is measured with coherent polarimetric radar at 24 GHz and 76 GHz. Road conditions are then recognized from the eigenvalues of Stokes or Mueller matrix, which are commonly known quantities in the field of radar polarimetry.

Radar polarimetry deals with measuring the polarization state of a radar frequency electromagnetic wave when the electromagnetic wave is re-polarized after it hits a radar target or a scattering surface, and is reflected. In radar polarimetry, the polarization state of radar waves under scattering conditions is usually described by formalisms including complex matrices.

Formally, the incident radar wave can be described by a two-component vector, wherein the vector components represent complex electric fields in a horizontal (Eₕⁱ) and a vertical direction (Eᵥⁱ), respectively. The reflected or scattered radar wave can be described by another two-component vector with vector components representing complex electric fields in the horizontal (Eₕ^{s}) and the vertical direction (Eᵥ^{s}). In this way, each scattering object is considered a polarization transformer, and the transformation from a transmitted wave vector to a received wave vector can be described as applying a matrix called scattering matrix to the vector representing the incident radar wave.

$$[ \begin{matrix}{E}_{h}^{s} \\ {E}_{v}^{s}\end{matrix} ] = [ \begin{matrix}{S}_{hh} & {S}_{hv} \\ {S}_{vh} & {S}_{vv}\end{matrix} ] \cdot [ \begin{matrix}{E}_{h}^{i} \\ {E}_{v}^{i}\end{matrix} ]$$

The diagonal matrix elements are usually called copolarized, the non-diagonal elements are called cross-polarized. This matrix contains all the information about the scattering process and the scatterer itself. Elements of the scattering matrix or an equivalent matrix, for instance the known Covariance matrix and the Coherency matrix, are observable power terms. Different relevant matrix formalisms exist and are used in radar polarimetry, such as Jones Matrix, S-matrix, Müller M-matrix and Kennaugh K-matrix. By measuring the scattering matrix or an equivalent, the strength and polarization of the scattered radar wave for an arbitrary polarization of the incident wave can be computed.

An outline of mathematical methods of treating scattering matrices and of extracting the information contained in a measured scattering matrix of observed power terms can be found, for instance, in Wolfgang-Martin Boerner, “Basic Concepts in Radar Polarimetry”, PoISARpro v3.0—Lecture Notes (available at http://earth.esa.int/landtraining07/polsar_basic_concepts.pdf). This document shall hereby be incorporated by reference in its entirety with effect for the jurisdictions permitting incorporation by reference.

### SUMMARY

It is an object of the invention to provide a radar system that is capable of generating improved safety by facilitating an optimized reaction of a driver of a vehicle with regard to potentially dangerous driving circumstances.

In one aspect of the present invention, the object is achieved by a polarimetric radar system that is configured for classifying objects ahead of a vehicle.

The phrase “configured to”, as used in this application, shall in particular be understood as being specifically programmed, laid out, furnished or arranged. The term “vehicle”, as used in this application, shall particularly be understood to encompass passenger cars, trucks and buses.

The polarimetric radar system comprises at least one radar transmitter unit, at least one radar receiving unit, a radar signal generating unit, a signal processing circuitry and a signal evaluation unit.

The at least one radar transmitter unit is configured to transmit radar waves of at least two different polarizations. The at least one radar receiving unit is configured to receive radar waves of at least two different polarizations. The radar signal generating unit is configured to generate and to provide radar waves to be transmitted by the at least one radar transmitter unit. The signal processing circuitry is configured to process the generated radar waves to be transmitted and the received radar waves. The signal evaluation unit is configured to receive processed signals from the signal processing circuitry and to estimate values for a permittivity of an object from a copolarized ratio of radar power derived from the received processed signals or to estimate values for a set of predetermined object parameters, including the permittivity of an object, on the basis of the received processed signals. The signal evaluation unit is further configured to select an object class that corresponds to a specific permittivity out of a plurality of permittivities from a plurality of predetermined object classes upon detecting a match of the estimated value of permittivity with the specific permittivity or to a specific predetermined set of object parameters, including the permittivity of an object, out of a plurality of predetermined sets of object parameters from a plurality of predetermined object classifications upon detecting a match of the estimated values for the set of object parameters with the specific predetermined set of object parameters.

The term “received radar waves”, as used in this application, shall particularly be understood as radar waves that are generated from transmitted radar waves by being reflected or scattered by objects. This can, for instance, be insured by an appropriate arrangement of the at least one radar transmitter unit and the at least one radar receiving unit.

The term “object parameter”, as used in this application, shall particularly be understood as a parameter that is characteristic for a specific object, and by that, can serve to distinguish the specific object from other objects. Examples of object parameters include, but are not limited to, size, distance, velocity along the line of sight, angle of arrival, roughness, scattering scenario and electric properties such as e.g. permittivity.

The transmitted radar waves are understood to be transmitted in a direction ahead of the vehicle, from where objects that might create dangerous driving circumstances can be expected.

In this way, a radar system for automotive applications with a low number of false negative classification results and a low number of false positive classification results can be provided.

The classifying may comprise a group of classes that includes, but is not limited to, “oil spill”, “black ice”, “snow”, “road bump”, “small animal” (such as small wild game), “big animal” (big wild game) and “pedestrian”.

Preferably, a predetermined set of object parameters comprises a predetermined range for each parameter of the set of object parameters. The term “match”, as used in this application, shall particularly be understood such that each estimated value for an object parameter of the set of predetermined object parameters shall lie within the predetermined range for the parameter, for all parameters of the set of object parameters.

Also preferably, the at least one radar transmitter unit is capable of providing continuous-wave (CW) radar energy.

In preferred embodiments, the polarimetric radar system further comprises modulation means for generating frequency-modulated (FM) radar waves (more preferred: frequency-modulated continuous-wave (FMCW)) to be transmitted by the at least one radar transmitter unit, and moreover comprises demodulation means for demodulating the received radar waves.

By that, absolute velocity and distance can be added as characteristic and important object parameters to the set of object parameters, thus facilitating improved classifying performance.

Preferably, the generated frequency-modulated radar waves to be transmitted are modulated linear in time. The radar frequency of the at least one radar transmitter unit may, for instance, slew up or down as a sawtooth wave or a triangle wave.

In some embodiments of the polarimetric radar system, the signal evaluation unit includes a microcontroller having at least one processor unit and at least one digital data memory unit to which the processor unit has data access. In this way, an automated measurement procedure of classifying objects ahead of a vehicle with the polarimetric radar system can be enabled.

A fast and undisturbed digital signal processing can be accomplished if the microcontroller further includes analog-to-digital converters that are electrically connected to the radar receiving unit. Such equipped microcontrollers are commercially available nowadays in many variations and at economic prices.

In some embodiments of the polarimetric radar system, the at least one radar transmitter unit comprises at least one transmitting antenna that is arrangeable in a front region of the vehicle, and the at least one radar receiving unit comprises at least one receiving antenna that is arrangeable in the front region of the vehicle. In this way, transmission of radar waves towards objects that might create dangerous driving circumstances and receiving radar waves that are generated from transmitted radar waves by being reflected or scattered by such objects can readily be accomplished.

The at least one transmitting antenna and the at least one receiving antenna may be arranged apart from each other in a spaced manner (bi-static arrangement), but a mono-static arrangement, in which the at least one transmitting antenna and the at least one receiving antenna are located nearby is also contemplated.

Preferably, the signal evaluation unit is configured to select an object classification from a plurality of predetermined object classifications in real time. The phrase “in real time”, as used in this application, shall particularly be understood as a response within specified and predetermined time constraints, which are appropriate for the specific application, such that an optimized reaction of the driver of a vehicle with regard to potentially dangerous driving circumstances can be facilitated.

In some embodiments of the polarimetric radar system, the at least one radar transmitter unit comprises a plurality of transmitting antennas forming a phased-array of antennas. This allows for applying one of the commonly known digital beam forming techniques to enable distinguishing of and classifying more than one object ahead of the vehicle. In a suitable embodiment of the polarimetric radar system, the phased-array of antennas can be used in combination with an appropriate digital beam forming technique to generate a real-time image of the copolarized ratio of radar power (copolarized: transmitted and received polarizations are the same) derived from the measurement of the radar waves reflected or scattered by an object, of a footprint in the field of view.

In another aspect of the invention, a method of classifying objects ahead of a vehicle by using a polarimetric radar system as disclosed herein is provided. The method comprises the following steps:
illuminating a scene ahead of the vehicle with radar waves having at least two different polarizations,
receiving radar waves of at least two different polarizations that are reflected by an object to be classified,
estimating values for a set of predetermined object parameters on the basis of the received radar waves,
comparing the estimated values for a set of predetermined object parameters with a plurality of predetermined sets of object parameters,
upon detecting a match of the estimated values for the set of object parameters with a specific predetermined set out of the plurality of predetermined sets of object parameters, assigning the classification corresponding to the specific predetermined set to the object, and
providing an information that is indicative of the classified object to a driver information system of the vehicle and/or to the driver of the vehicle.

The benefits described in context with the disclosed polarimetric radar system apply to the method to the full extent.

Preferably, the step of illuminating the scene ahead of the vehicle comprises illuminating the scene with frequency-modulated continuous radar waves (FMCW) to allow for adding absolute velocity, particularly perpendicular to the line of sight, and distance to the set of object parameters for facilitating improved classifying performance.

Thus, in some embodiments of the method, the step of estimating values for a set of predetermined object parameters includes estimating at least one out of velocity, direction and distance of the object with respect to the vehicle. For instance, this can be achieved by exploiting a frequency content of the received radar waves.

In some embodiments of the method, the step of estimating values for a set of predetermined object parameters includes estimating a permittivity of the object from a copolarized ratio of radar power (copolarized: transmitted and received polarizations are the same) derived from the measurement of the radar waves reflected or scattered by an object.

The permittivity of an object is a complex number. The permittivity is estimated for the specific frequency of the transmitted incident radar wave. In this way, the permittivity can be added to the set of predetermined object parameters, which allows classifying of and distinguishing between various potentially deposited layers on a roadway, such as black ice, water, oil spill, and so forth.

An especial beneficial solution can be accomplished if the step of estimating values for a set of predetermined object parameters includes estimating a permittivity of the object from a copolarized ratio of radar power derived from the measurement of the radar waves reflected by an object in the specular direction. In this direction an incidence angle is equal to a scattering angle, and for all surface scattering models (smooth, medium rough and rough), the copolarized ratio of the scattering coefficients is independent of the target roughness. This can be especially beneficial for distinguishing between a layer of water and a layer of ice that may be deposited on the roadway.

In some embodiments of the method, the step of estimating values for a set of predetermined object parameters includes steps of performing a polarimetric decomposition of a matrix formed by making use of the received radar waves, and identifying at least one object from the polarimetric decomposition.

The polarimetric decomposition is a presentation of the matrix that describes the reflection or scattering of the incident radar waves as a linear sum of basis matrices multiplied with corresponding coefficients to express the matrix as a linear sum of scattering mechanisms.

Many schemes of performing a polarimetric decomposition of a scattering matrix are known in the art and are described in relevant textbooks, and also in the cited reference of Wolfgang-Martin Boerner, “Basic Concepts in Radar Polarimetry”. Some polarimetric decompositions are model-based and require a priori knowledge about the nature of the scattering object as an input, and some polarimetric decomposition schemes are not model-based. Both types of polarimetric decomposition schemes are contemplated for use in the method disclosed herein.

In yet another aspect of the invention, a non-transitory computer-readable medium is used to provide a software module for controlling automatic execution of steps of an embodiment of the method disclosed herein.

The method steps to be conducted are converted into a program code of the software module, wherein the program code is implementable in a digital memory unit of the polarimetric radar system; that is, it is stored on the computer-readable medium and is executable by a processor unit of the polarimetric radar system. Preferably, the digital memory unit and/or processor unit may be a digital memory unit and/or a processing unit of the signal evaluation unit of the polarimetric radar system. The processor unit may, alternatively or supplementary, be another processor unit that is especially assigned to execute at least some of the method steps.

The software module can enable a robust and reliable execution of the method in an automatic manner and can allow for a fast modification of method steps.

These and other aspects of the invention will be apparent from and elucidated with reference to the embodiments described hereinafter.

### BRIEF DESCRIPTION OF THE DRAWINGS

Further details and advantages of the present invention will be apparent from the following detailed description of not limiting embodiments with reference to the attached drawing, wherein:

FIG. 1 is a schematic circuit diagram of a polarimetric radar system in accordance with the invention,

FIG. 2 shows the polarimetric radar system pursuant to FIG. 1 installed in a vehicle in a top view and a side view,

FIG. 3 is a flowchart of an embodiment of a method in accordance with the invention, and

FIG. 4 schematically shows a diagram of evaluating radar waves received by the radar receiving unit of the polarimetric radar system pursuant to FIG. 1.

### DESCRIPTION OF THE ILLUSTRATED EMBODIMENTS

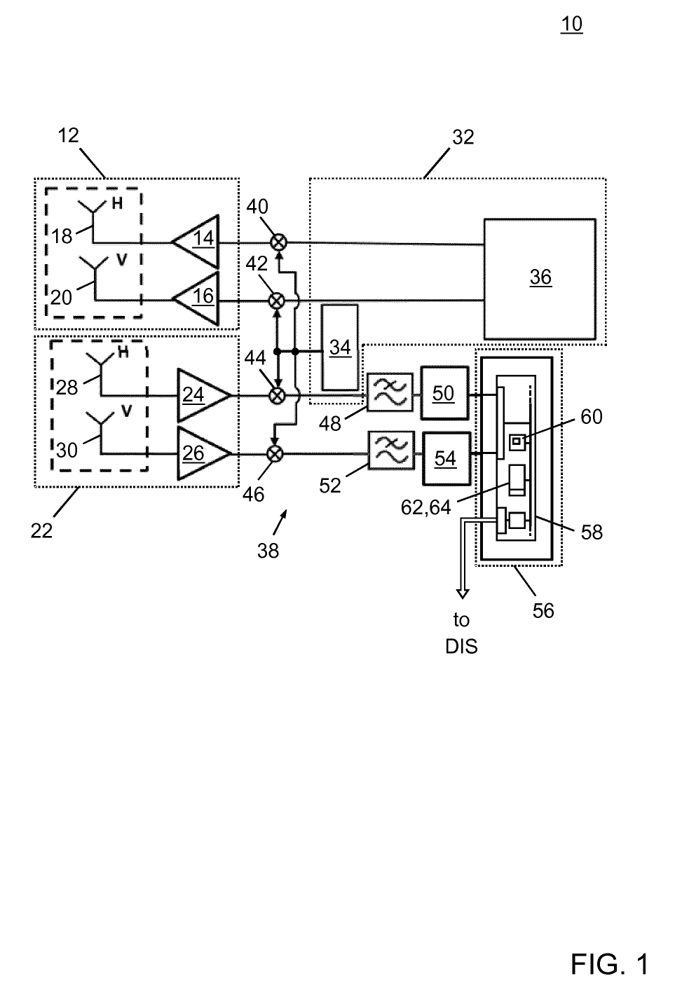

FIG. 1 is a schematic circuit diagram of a polarimetric radar system 10 in accordance with an embodiment of the invention, for classifying objects ahead of a vehicle. The polarimetric radar system 10 includes:
a radar transmitter unit 12,
a radar receiving unit 22,
a radar signal generating unit 32,
a signal processing circuitry 38, and
a signal evaluation unit 56.

The radar transmitter unit 12 comprises a first power amplifier 14 and a second power amplifier 16, which are identically designed, and two transmitting antennas 18, 20 that are designed as patch antennas. A first one 18 of the two transmitting antennas 18, 20 is configured to transmit radar waves with a horizontal polarization. A second one 20 of the two transmitting antennas 18, 20 is configured to transmit radar waves with a vertical polarization. Each one of the power amplifiers 14, 16 is electrically connected with an output port to one of the transmitting antennas 18, 20.

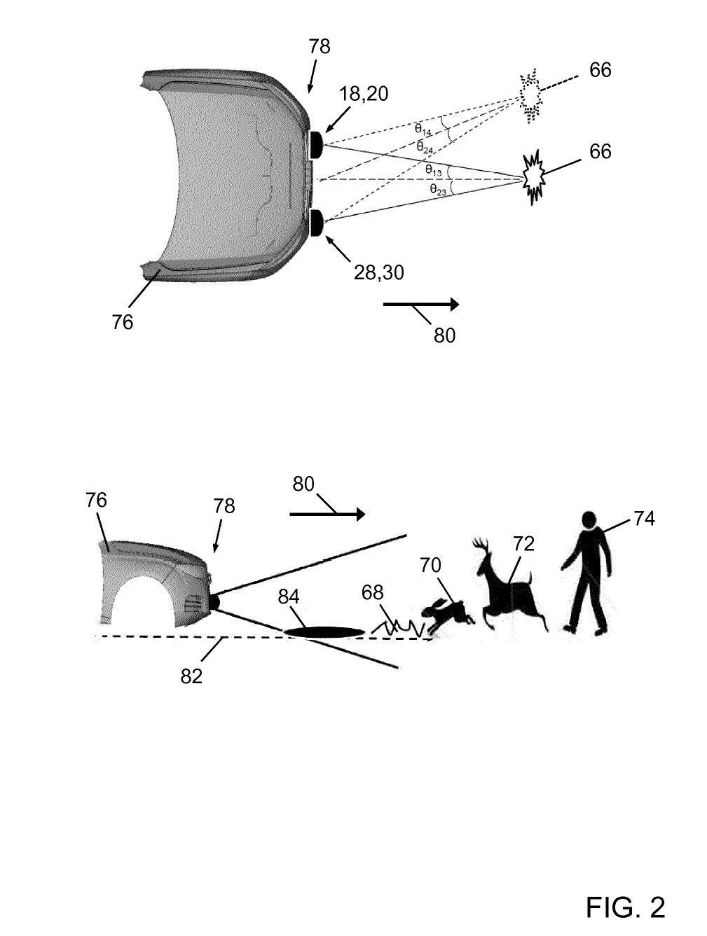

The two transmitting antennas 18, 20 are e.g. located at a front region 78 of the vehicle 76 and are directed in normal driving direction 80 (FIG. 2). The radar transmitter unit 12 is therefore configured for transmitting radar waves of horizontal and vertical polarization in a direction 80 ahead of the vehicle 76. As is shown in the lower part of FIG. 2, the radar waves are transmitted such that the road surface 82 with potential deposited surface layers 84 such as oil spill, black ice or snow is illuminated by the transmitting antennas 18, 20 as well as potentially occurring objects 66 such as road bumps 68, small animals 70, big animals 72, pedestrians 74, and the like will be.

It is noted herewith that the terms “first”, “second”, etc. are used in this application for distinction purposes only, and are not meant to indicate or anticipate a sequence or a priority in any way.

Although in this specific embodiment the radar transmitter unit 12 comprises two transmitting antennas 18, 20, it is also contemplated for other embodiments that the radar transmitter unit can comprise a plurality of more than two transmitting antennas forming a phased-array of antennas. Additional hardware needs to be provided in this case, for instance for adjusting a phase relationship between the various antennas, as is well known in the art.

Referring again to FIG. 1, the radar receiving unit 22 comprises a first low-noise amplifier 24 and a second low-noise amplifier 26 and two receiving antennas 28, 30 that are designed as patch antennas. A first one 28 of the receiving antennas 28, 30 is configured to receive radar waves having a horizontal polarization. A second one 30 of the two receiving antennas 28, 30 is configured to receive radar waves with a vertical polarization. Each one of the receiving antennas 28, 30 is electrically connected to an input port of one of the low-noise amplifiers 24, 26.

The two receiving antennas 28, 30 are located at the front region 78 of the vehicle 76 with their main sensitivity lobes pointing in the normal driving direction 80, and are arranged in a spaced manner with regard to the two transmitting antennas 18, 20 (FIG. 2). The radar receiving unit 22 is therefore configured for receiving radar waves of horizontal and vertical polarization that propagate in a direction opposite to the normal driving direction 80, in particular for receiving radar waves that are generated from radar waves transmitted by the radar transmitting antennas 18, 20 and are reflected or scattered by objects 66 ahead of the vehicle 76.

With reference to FIG. 1, the radar signal generating unit 32 comprises a radar local oscillator 34 and a sweep generator 36. The radar local oscillator 34 is configured to generate radar waves at a radar frequency of, for instance, about 24.0 GHz, and is capable of operating in a continuous wave-mode. The sweep generator 36 is configured to generate a sinusoidal signal of constant amplitude with a linearly varying frequency with a bandwidth of e.g. 200 MHz at a radar frequency of 24 GHz.

The signal processing circuitry 38 is configured for processing the generated radar waves to be transmitted. To this end, the signal processing circuitry 38 comprises a first 40 and a second electronic multiplying frequency mixer 42 that serve as modulation means. The signal from the sweep generator 36 and the signal from the radar local oscillator 34 are electrically connected to the first frequency mixer 40 and to the second frequency mixer 42. An output signal of the first frequency mixer 40 is fed to the first power amplifier 14 of the two power amplifiers 14, 16, which serves to supply the first transmitting antenna 18 with radar power. An output signal of the second frequency mixer 42 is conveyed to the second power amplifier 16, which serves to supply the second transmitting antenna 20 with radar power.

The output signals of the first 40 and the second frequency mixer 42 include a sum and a difference of the frequency of the radar local oscillator 34 and the frequency of the sweep generator 36. The difference frequency signal is eliminated by an appropriate filter (not shown).

In this way, frequency-modulated continuous radar waves can be generated that are to be transmitted via the first transmitting antenna 18 and the second transmitting antenna 20 of the radar transmitter unit 12.

The signal processing circuitry 38 is further configured for processing the received radar waves. To this end, the signal processing circuitry 38 comprises a third 44 and a fourth electronic multiplying frequency mixer 46 that serve as demodulation means. An output port of the first low-noise amplifier 24, which carries a signal of received radar waves with horizontal polarization, and the radar local oscillator 34 are electrically connected to the third frequency mixer 44 of the signal processing circuitry 38. An output port of the second low-noise amplifier 26, which carries a signal of received radar waves with vertical polarization, and the radar local oscillator 34 are electrically connected to the fourth frequency mixer 46 of the signal processing circuitry 38.

The output signals of the third 44 and the fourth frequency mixer 46 include a sum and a difference of the frequency of the radar waves transmitted by the transmitting antennas 18, 20 and the frequency of the radar local oscillator 34. The sum frequency signal is eliminated from the output signal of the third frequency mixer 44 by a subsequent low-pass filter 48 of the signal processing circuitry 38, and only the difference signal is digitally converted by an analog-to-digital converter (ADC) 50. The output signal of the fourth frequency mixer 46 is processed by another low-pass filter 52 and digitally converted by another ADC 54 in the same manner.

The filtered and digitally converted output signals are fed to input ports of the signal evaluation unit 56 that is configured to receive processed signals from the signal processing circuitry 38. The signal evaluation unit 56 includes a microcontroller 58 having a processor unit 60 and a digital data memory unit 62 to which the processor unit 60 has data access. The digital data memory unit 62 comprises a non-transitory computer-readable medium. In FIG. 1, the signal evaluation unit 56 and the ADCs 50, 54 are shown as separate units. Actually, the ADCs 50, 54 may be integral parts of the microcontroller 58.

As will be described in more detail hereinafter, the signal evaluation unit 56 is configured to estimate values for a set of predetermined object parameters on the basis of the received processed signals. The signal evaluation unit 56 is further configured to select an object classification that corresponds to a specific predetermined set of object parameters out of a plurality of predetermined sets of object parameters from a plurality of predetermined object classifications upon detecting a match of the estimated values for the set of object parameters with the specific predetermined set of object parameters out of the plurality of predetermined sets of object parameters. The microcontroller 58 is configured to select the object classification in real-time.

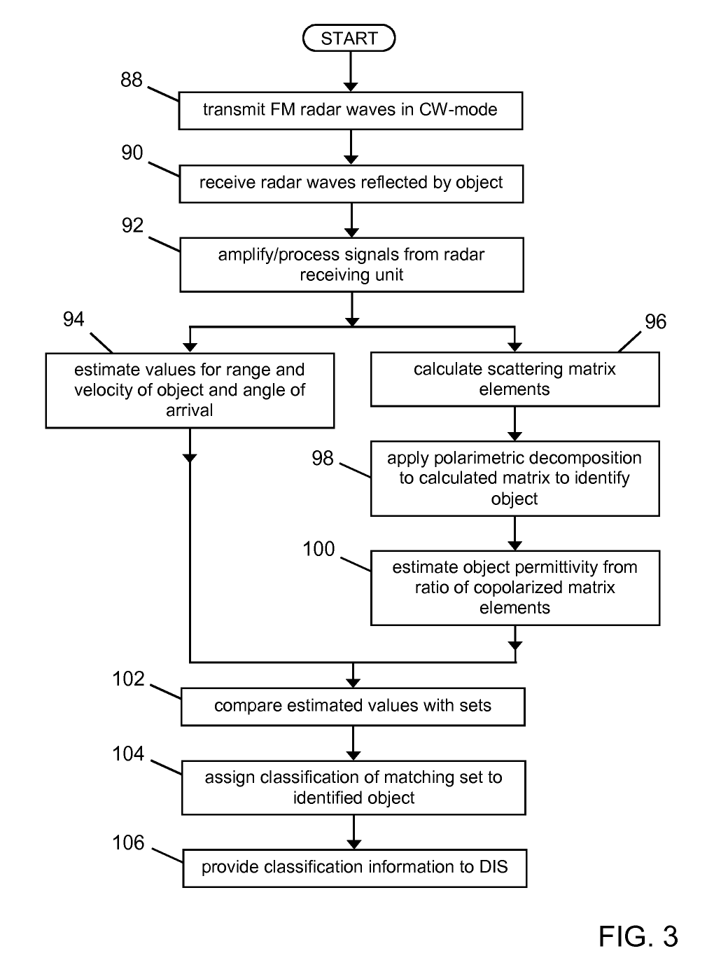

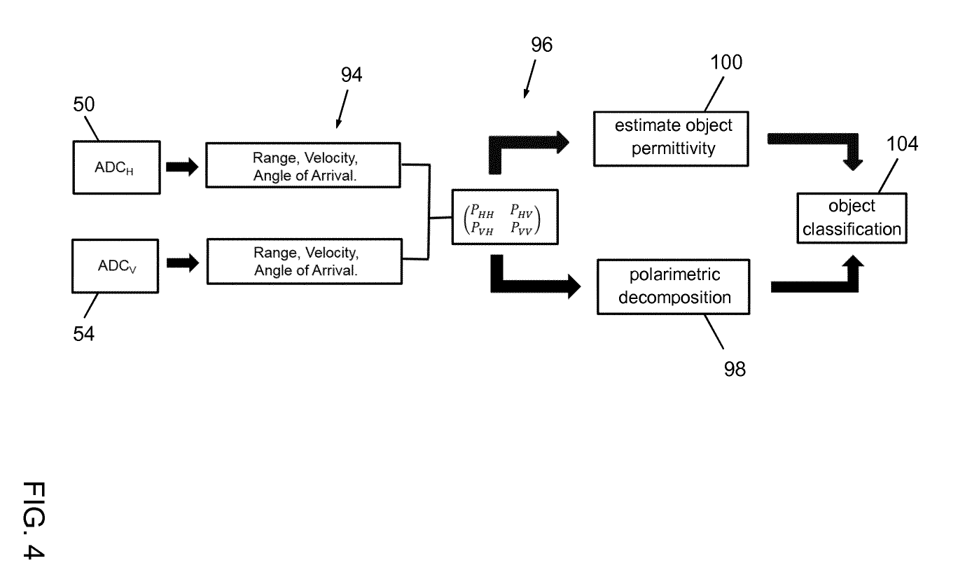

In the following, an embodiment of a method of classifying objects 66 ahead of a vehicle 76 by using a polarimetric radar system 10 pursuant to FIG. 1 will be described with reference to FIGS. 3 and 4. FIG. 3 provides a flowchart of the method as a whole, whereas a detailed diagram of signal evaluating and object classifying as part of the method is given in FIG. 4. In preparation of operating the polarimetric radar system 10, it shall be understood that all involved units and devices are in an operational state and configured as illustrated in FIGS. 1 and 2.

In order to be able to carry out the method automatically and in a controlled way, the microcontroller 58 comprises a software module 64 (FIG. 1). The method steps to be conducted are converted into a program code of the software module 64. The program code is implemented in the digital data memory unit 62 of the microcontroller 58 and is executable by the processor unit 60 of the microcontroller 58. The software module 64 also includes a subroutine for performing a polarimetric decomposition of a scattering matrix. Execution of the method may be initiated by starting the vehicle engine.

Referring now to FIG. 3, as a first step 88 of the method, illuminating a scene ahead of the vehicle 76 with frequency-modulated radar waves having horizontal polarization and with frequency-modulated radar waves having vertical polarization by simultaneously providing continuous-wave radar power to the two transmitting antennas 18, 20 commences.

Radar waves having horizontal polarization and radar waves having vertical polarization that are reflected by an object 66 to be classified are received by the radar receiving unit 22 in another step 90, and the generated signals are amplified and signal-processed by the signal processing circuitry 38 as described above, in the following step 92.

In the next step 94 of the method, values for a set of predetermined object parameters are estimated on the basis of the received radar waves. The set of predetermined object parameters comprises a distance between the object 66 and the vehicle 76 (range), the velocity of the object 66 relative to the vehicle 76 and an angle of arrival of the radar waves reflected by the object 66 to be classified.

In another step 96 of the method, elements of a scattering matrix are calculated on the basis of the received radar waves. The matrix contains all the information about the reflection process and the object 66 and comprises elements of copolarized radar power (co-polarized: transmitted and received polarizations are the same) derived from the measurement of the radar waves reflected by the object 66.

In another step 98 of estimating values for a set of predetermined object parameters, the subroutine for performing a polarimetric decomposition is applied to the calculated matrix, and the object 66 is identified from the polarimetric decomposition.

From a ratio of the elements of copolarized radar power reflected by the object 66, a permittivity of the object 66 is estimated as a value for another parameter that forms part of the set of predetermined object parameters in another step 100 of estimating values.

In the next step 102 of the method, the estimated values for the set of predetermined object parameters are compared with a plurality of predetermined sets of object parameters. For each object parameter of the set of object parameters, a predetermined range resides in the digital data memory unit 62. The step 102 of comparing includes checking if the estimated value for an object parameter lies within the predetermined range for the object parameter, for all parameters of the set of object parameters. If this condition is fulfilled for a specific predetermined set of object parameters, the estimated values are said to match the specific predetermined set of object parameters.

Upon detecting a match of the estimated values for the set of object parameters with a specific predetermined set out of the plurality of predetermined sets of object parameters, the classification corresponding to the specific predetermined set is assigned to the identified object 66 in another step 104.

Then, in a further step 106 of the method, an information that is indicative of the classified object 66 is provided to a driver information system of the vehicle and/or to a driver of the vehicle 76.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, which is meant to express a quantity of at least two. The mere fact that certain measures are recited in mutually different dependent claims does not indicate that a combination of these measures cannot be used to advantage. Any reference signs in the claims should not be construed as limiting scope.

1. A polarimetric radar system for classifying objects ahead of a vehicle, the radar system comprising:
at least one radar transmitter unit that is configured for transmitting radar waves of at least two different polarizations,
at least one radar receiving unit that is configured for receiving radar waves of at least two different polarizations,
a radar signal generating unit that is configured to generate and to provide radar waves to be transmitted by the at least one radar transmitter unit,
a signal processing circuitry that is configured to process the generated radar waves to be transmitted and the received radar waves, and
a signal evaluation unit that is configured to receive processed signals from the signal processing circuitry, and to estimate a value for a permittivity of an object from the received processed signals, and to select an object class that corresponds to a specific permittivity out of a plurality of permittivities from a plurality of predetermined object classes upon detecting a match of the estimated value of permittivity with the specific permittivity.

2. The polarimetric radar system as claimed in claim 1, wherein the signal evaluation unit is configured to estimate values for a set of predetermined object parameters, including the permittivity of the object, on the basis of the received processed signals and to select an object class that corresponds to a specific predetermined set of object parameters, including the permittivity of the object, out of a plurality of predetermined sets of object parameters from a plurality of predetermined object classifications upon detecting a match of the estimated values for the set of object parameters with the specific predetermined set of object parameters.

3. The polarimetric radar system as claimed in claim 1, further comprising modulation means for generating frequency-modulated radar waves to be transmitted by the at least one radar transmitter unit, and comprising demodulation means for demodulating the received radar waves.

4. The polarimetric radar system as claimed in claim 1, wherein the signal evaluation unit includes a microcontroller having at least one processor unit and at least one digital data memory unit to which the processor unit has data access.

5. The polarimetric radar system as claimed in claim 1, wherein the at least one radar transmitter unit comprises at least one transmitting antenna that is arrangeable in a front region of the vehicle, and wherein the at least one radar receiving unit comprises at least one receiving antenna that is arrangeable in the front region of the vehicle.

6. The polarimetric radar system as claimed in claim 1, wherein the signal evaluation unit is configured to select an object class from a plurality of predetermined object classifications in real time.

7. The polarimetric radar system as claimed in claim 1, wherein the at least one radar transmitter unit comprises a plurality of transmitting antennas forming a phased-array of antennas.

8. A method of classifying objects ahead of a vehicle by using a polarimetric radar system as claimed in claim 1, the method comprising steps of:
(a) illuminating a scene ahead of the vehicle with radar waves having at least two different polarizations,
(b) receiving radar waves of at least two different polarizations that are reflected by an object to be classified,
(c) estimating values for a set of predetermined object parameters including a permittivity of the object on the basis of the received radar waves,
(d) comparing the estimated values for a set of predetermined object parameters with a plurality of predetermined sets of object parameters,
(e) upon detecting a match of the estimated values for the set of object parameters, including the permittivity of the object, with a specific predetermined set out of the plurality of predetermined sets of object parameters, assigning the classification corresponding to the specific predetermined set to the object, and
(f) providing an information that is indicative of the classified object to a driver information system of the vehicle and/or to the driver of the vehicle.

9. The method as claimed in claim 8, wherein the step of illuminating the scene ahead of the vehicle comprises illuminating the scene with frequency-modulated continuous radar waves.

10. The method as claimed in claim 8, wherein the step of estimating values for a set of predetermined object parameters includes estimating at least one out of velocity, direction and distance of the object with respect to the vehicle.

11. The method as claimed in claim 8, wherein the permittivity of the object is estimated from a copolarized ratio of radar power derived from the measurement of the radar waves reflected or scattered by the object.

12. The method as claimed in claim 11, wherein the permittivity of the object is estimated from a copolarized ratio of radar power derived from the measurement of the radar waves reflected by the object in the specular direction.

13. The method as claimed in claim 8, wherein the step of estimating values for a set of predetermined object parameters includes a step of performing a polarimetric decomposition of a matrix formed by making use of the received radar waves, and identifying at least one object from the polarimetric decomposition.

14. A non-transitory computer-readable medium for controlling automatic execution of the method as claimed in claim 8, wherein method steps (c) through (f) are stored on the computer-readable medium as a program code, wherein the computer-readable medium comprises a part of the polarimetric radar system or a separate control unit and the program code is executable by a processor unit of the polarimetric radar system or a separate control unit.
